(19) United States
(12) Patent Application Publication
(10) Pub. No.: US 2005/0068611 A1
(43) Pub. Date: Mar. 31, 2005

(54) Surface-free ring cavity optical resonator corresponding communication and/or video projection apparatus

(76) Inventors: Patrice Feron, Lannion (FR); Raymond Le Bras, Lannion (FR)

Correspondence Address: Robert M Angus;Westman Champlin & Kelly, 900 Second Avenue South, International Centre-Suite 1600, Minneapolis, MN, 55402-3319, US

(21) Appl. No.: 10/498,654

(22) PCT Filed: Dec. 12, 2002
(86) PCT No.: PCT/FR02/04332

(30) Foreign Application Priority Data
Dec. 12, 2001 (FR) 0116065

(51) Int. Cl. H01S 3/00

(52) U.S. Cl. 359/333

(57) ABSTRACT

This invention relates to a zero surface optical ring resonator (250, 450) comprising a plurality of modules, each module itself comprising means (251, 470, 471) of separating the polarization of an incident beam according to a polarization base ((x,y), (x,z)), a first and a second arm, one of the arms comprising means (214, 213, 234, 233) of redirecting and changing the polarization of an output beam, the said resonator also comprising amplification means (215, 225, 205) in at least one of the said modules, to amplify at least one of the said output beams located on the path of the beam(s) to be amplified, between the polarization separation means and the redirection and polarization changing means belonging to the arm concerned.

This invention relates to the field of lasers.

More precisely, the invention relates to ring laser components.

A laser is an optical oscillator. Like all oscillators, it is composed of an amplifier and an adapted counter-reaction loop.

In the case of a laser, the amplifier is formed from a medium capable of amplifying the spontaneous emission (by stimulated emission). This means that if a light beam passes through such a source, its intensity when it leaves is greater than its intensity when it enters.

The counter-reaction loop is composed of a resonant optical cavity. This cavity is composed of mirrors arranged such that light circulates between them and remains there like in a reservoir.

The laser effect and its characteristics (intensity, polarisation, emission wavelength, line width, etc.) are the result of matching between these two main elements that are the amplifying medium and the optical resonator.

Lasers are known that comprise used optical cavities of the “two mirrors” type (for example a Fabry-Perot interferometer). This type of resonator leads to the generation of a stationary wave inside the cavity. The first consequence may be the non-uniform saturation of the amplifying medium (λ/2 intervals, where λ is the wavelength of the amplified light signal). This effect is conventionally known as “spatial hole burning”. It has disadvantages, particularly a reduction in the oscillator performances in terms of intensity and also in terms of emission stability (amplitude noise, phase noise, partition noise corresponding to mode skips).

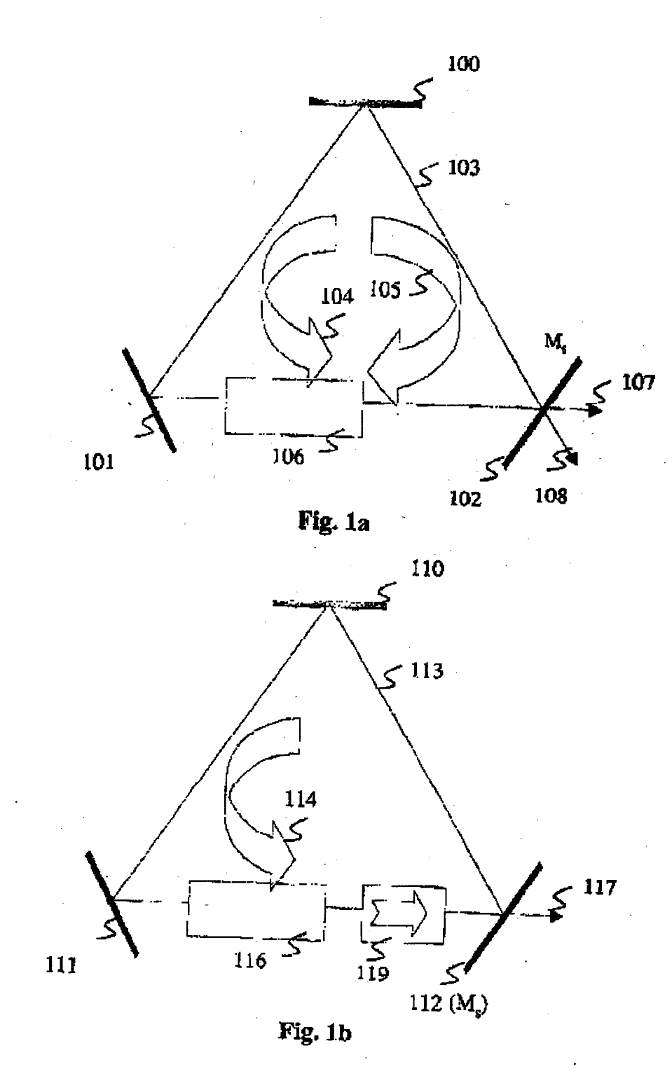

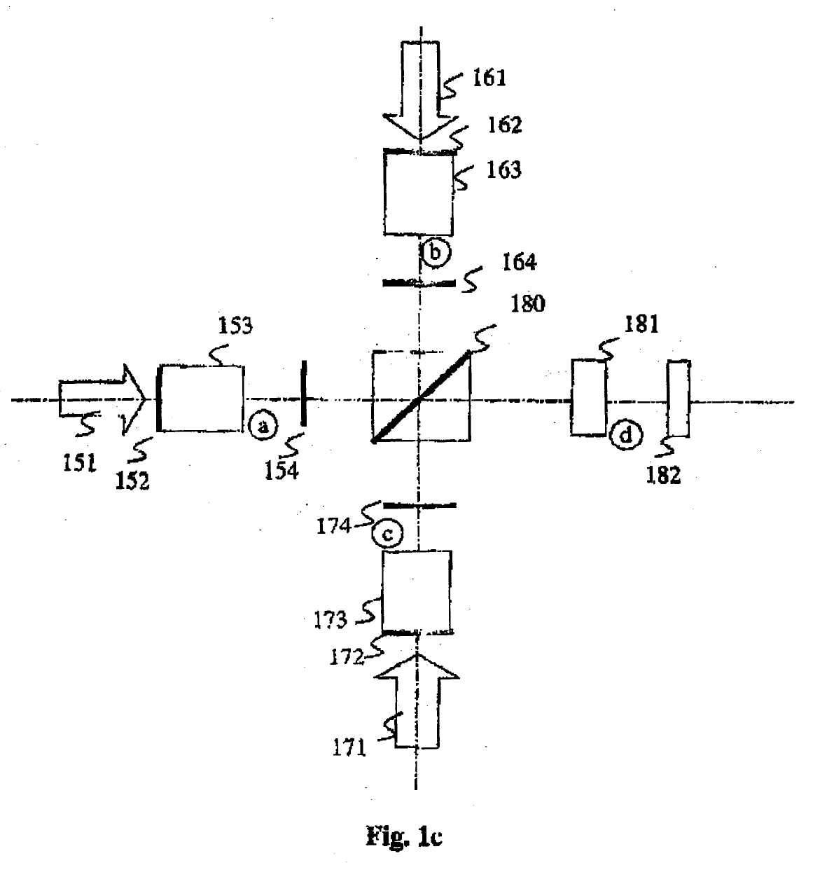

The solution to this problem has traditionally been provided using a ring resonant cavity described with reference to FIGS. 1a and 1b.

FIG. 1a shows a ring cavity without an optical diode. This cavity is formed with three mirrors 100 to 102 placed at the vertex of an equilateral triangle and oriented such that a light beam 103 is reflected in sequence by the three mirrors and passes through an amplifying medium 106 located between the mirrors 101 and 102. According to the embodiment in FIG. 1a, the light beam 103 can follow the two possible directions of the path through the cavity and two beams 107 and 108 emerge from the mirror Ms 102.

FIG. 1b shows a variant of a cavity that comprises the same elements as the cavity in FIG. 1a, and also an optical diode 109 placed for example between the amplifying medium 106 and the mirror 112, giving priority to one direction of the path through the cavity (progressive wave inside the resonator). According to this variant, a single emergent beam 117 is obtained at the output 112 with a total intensity equal to the sum of the intensities of the two beams 107 and 108.

The “optical diode” can be introduced due to the geometric size given to the amplifying medium. To optimise the gain of the amplifier, the amplifier is cut at a Brewster angle in order to give priority to a rectilinear polarisation axis of the laser light. In other words, a quantification axis is fixed for the amplifying medium.

Nevertheless, these ring cavities have several disadvantages, and particularly:
they have an extended cavity which is harmful to the compactness and stability of these structures;
furthermore, the resonator configuration is such that longitudinal pumping of the amplifier medium is difficult.

Monolithic microchip ring resonators are also known which have the advantage of better compactness.

However, they have the disadvantage that they can only achieve a modest transmitted power (about 100 mW).

Furthermore, for most of them, it is impossible to introduce elements into the cavity in order to make a selection or with an active purpose (generation of harmonics or pulse operation using a passive Q-switch).

A resonator described in documents written by M. Mac Donald, T. Graf, J. Balmer and H. Weber is also known, the documents being entitled “Configuration Q-Switching in a diode pumped multirod Variable configuration resonator” published in the “IEEE Journal of Quantum Electronics”, Vol. 34, No. 2, February 1998, where Q is a quality factor of the resonator also called the overvoltage factor, and a “zero surface” ring resonator illustrated in the document “Efficient polarised output from end-pumped multirod resonators” published in the “Optics Communications” review Vol. 160 (1999) Feb. 15, 1999 and published by Elsevier.

The cavity described in the first of these documents and illustrated with reference to FIG. 1c is a progressive wave cavity supported on a cavity comprising:
a polarisation separator 180;
three mirrors 152, 162 and 172 each associated with a quarter wave plate 154, 164 and 174 respectively, a laser crystal 153, 163 and 173 respectively being inserted between each mirror and the associated quarter wave plate;
an output 182; and
a switch 181 placed between the separator 180 and the output 182.

The mirrors 152 and the output 182, and also the mirror 162 and 172, form the branches of a cross that intersect at the separator 180.

Pumps 151, 161 and 171 supply the cavity through the mirrors 152, 162 and 172 respectively.

This configuration does not include a quarter wave plate between the separator 180 and the output 182. Thus, this article does not divulge a ring resonator. On the other hand, according to the variant described in the second article mentioned above, a λ/4 plate is inserted. Thus, this arrangement provides a “ring” cavity (zero surface ring). Note that this structure does not in any way require insertion of an optical diode (association of a Faraday rotator and a crystalline plate with an optical activity) in order to give priority to one direction of the path to obtain the maximum gain on one of the paths. This component is necessary in the case of a traditional ring laser in which the beams corresponding to the two possible paths do not enable superposition of emerging beams.

However, this technique has the disadvantage that it enables operation with good efficiency, with isotropic amplifier media only.

The various aspects of the invention are intended to overcome these disadvantages according to prior art.

More precisely, a first objective of the invention is to provide a resonator with a high emission power, for example of the order of 1 Watt, while having a low noise. In particular, one purpose of the invention is to supply a resonator adapted to continuously or quasi-continuously emitting a high power, for example of the order of several watts.

Another purpose of the invention is to implement a resonator with a wide variety of emission wavelengths, particularly in narrow band if the cavity is extended and in wider band if the cavity is compact.

Another purpose of the invention is to supply a laser resonator enabling short cavities.

One purpose of the invention is to enable introduction and optimum use of optically anisotropic media, either amplifying media or non-linear crystals for the generation of harmonics (these harmonics are not necessarily higher, since they can be added or subtracted).

Another purpose of the invention is to supply a resonator that can be used for various applications.

Another purpose of the invention is to enable an optimised configuration for longitudinal pumping.

Another purpose of the invention is to enable the resonator with a compact structure.

Consequently, the invention proposes an optical ring resonator allowing at least one optical beam to circulate inside the resonator forming a zero surface ring, the resonator comprising a plurality of modules, each module itself comprising:
means of separating the polarization of an incident beam entering the module, according to a polarization base;
a first arm; and
a second arm;
the separation means being capable of separating:
a first component of the incident beam oriented along a first direction of the polarisation base, forming a first output beam emitted to the first arm; and
a second component of the incident beam oriented along a second direction of the polarisation base, forming a second output beam emitted to the second arm;
at least one first and one second arm comprising means of redirecting and changing the polarization of the first and second output beam respectively, the redirection and polarization changing means being adapted to redirecting the first or second output beam to the separation means and changing the polarisation direction of the first or second output beam to form an incident beam input into another of the modules;
   the resonator being remarkable in that it also comprises amplification means in at least one of the modules, to amplify at least one of the first or second output beams, referred to as at least one beam to be amplified, the amplification means being adapted to being associated with longitudinal or transverse pumping means and being located on the path of the at least one beam to be amplified, between the polarization separation means and the redirection and polarization changing means belonging to the arm concerned.

Thus, the invention can be used with longitudinal pumping that can be efficient (for example of the order of 30 to 40%) in terms of the optical balance and efficiency. Moreover, the configuration of the resonator is optimised for longitudinal pumping of the different active media. In this way, the invention can easily obtain powers of more than 1 Watt.

Moreover, a rectilinearly polarised wave passes through the amplifying medium in one direction, and a wave with the same nature but with perpendicular polarisation passes through it in the other direction. Consequently, the amplifying medium has an optimum gain for each of these path directions.

The resonator can also be used with a short cavity, which has the following consequences:
a possibility of a fairly wide laser line, which is conducive to use of a Raman laser pumping type with a fairly wide emission; and
a small number of longitudinal modes, which, together with a lack of HSB, will reduce partition noise, consequently stabilization will be easier than with a stationary wave laser structure.

The resonator obtained according to the invention may also have a compact structure: apart from the pumping system, the solid laser structure may in particular be contained within the volume of a packet of cigarettes.

Preferably, the total length of the ring resonator cavity (and therefore the length of the arms) is adapted to the required wavelength.

According to one particular characteristic, the resonator is remarkable in that the separation means comprise a polarisation separator cube.

The polarisation separator cube may be specified “wide band” in other words it will separate polarisations in a wide spectral range. This type of “wide band” polarisation separator cube can advantageously be used in the case of a multiple wavelength resonator.

According to one particular characteristic, the resonator is remarkable in that the separation means comprise a semi-transparent plate with polarisation separation.

Note that the semi-transparent plate used is composed particularly of a pellicular system.

According to one particular characteristic, the resonator is remarkable in that the separation means are common to all modules.

Thus, the invention enables a very compact installation that is very easy to use.

According to one particular characteristic, the resonator is remarkable in that all modules comprise at least two sub-assemblies, all modules of the same subassembly of modules sharing common separation means.

Thus, the resonator may be used in the form of a cascaded structure, particularly to enable greater emission power.

According to one particular characteristic, the resonator is remarkable in that the redirection and polarisation changing means comprise:
a mirror positioned so as to reflect the first or second output beam; and
means of shifting the phase of the first or second output beam;
such that the first or second output beam is:
firstly subjected to a phase shift through an angle equal to π/2 radians by the phase shifting means;
then reflected by the mirror; and
finally, the phase is shifted again by an angle equal to π/2 radians by the phase shifting means.

Thus, pumping is done along two orthogonal axes in the amplification means, which improves the gain.

In this case, the mirror preferably comprises:
a cut and polished substrate (support) with an appropriate radius of curvature; and
a metallised layer or a dielectric stack enabling complete reflection of a light beam at the wavelength of the resonator.

The substrate may be separated from the phase shifting means.

The phase shifting means and the mirror may form a monolithic optical element with the substrate forming part of the phase shifting means, to increase the compactness of the resonator and/or to increase the emission power; the monolithic optical element thus formed may for example be made by deposition of a dielectric stack on a quarter wave plate or a Fresnel rhombohedron.

In order to optimise the efficiency of the resonator, particularly in the case of longitudinal pumping, the outer face (pump side) of the mirror may be provided with an anti-reflection treatment.

According to one particular characteristic, the resonator is remarkable in that the phase shifting means and the amplification means comprise the same undoped material in the phase shifting means and doped material in the amplification means and are adjacent such that the first or second output beam transits from the amplification means to the phase shifting means and vice versa without changing medium.

In this way, a resonator structure in which the phase shifting means comprise a doped crystal to obtain the gain and an amplification medium comprising the same undoped crystal are adjacent (in other words placed side by side without any space between them), to avoid losses related to changing the medium and due to the index change.

According to one particular characteristic, the resonator is remarkable in that the phase shift means comprise a quarter wave plate.

According to one particular characteristic, the resonator is remarkable in that the phase shift means comprise a Fresnel rhombohedron.

According to one particular characteristic, the resonator is remarkable in that the mirror is concave.

According to one particular characteristic, the resonator is remarkable in that the mirror is plane.

Thus, a mirror using the resonator may be:
concave, with a radius of curvature guaranteeing the stability, particularly for large cavities; or
plane for an implementation particularly suitable for small cavity resonators, particularly with a total length of less than 1 cm.

According to one particular characteristic, the redirection and polarisation changing means comprise:
a mirror positioned to reflect the first or second output beam; and
means of rotating the first or second output beam by an angle equal to π/4 radians.

Thus, after a forward-return path in the rotation means, a beam will have been rotated by π/2 radians, so that in particular the gain can be improved by amplifying the beam along two orthogonal directions in the amplification means.

For example, the rotation means may be a Faraday rotator that in particular widens the passband of the rotation means, or more generally a medium provided with a magnetic rotating power associated with a magnetic field.

According to one particular characteristic, the resonator is remarkable in that the amplification means comprise an anisotropic material with its specific polarisation axes corresponding to the polarisation directions of said polarisation base.

Thus, the invention enables high emission powers and good efficiency, optical beams passing through the anisotropic amplifying medium for which the specific polarisation axes correspond to the corresponding polarisation directions in each of the two propagation directions of the optical signal.

According to one particular characteristic, the resonator is remarkable in that the anisotropic material belongs to the group comprising:
anisotropic crystals; and
glass with dichroism.

According to one particular characteristic, the resonator is remarkable in that the anisotropic material belongs to the group comprising:
Nd:YAP type materials;
Nd:YVO4 type materials; and
Er:YAP type materials.

According to one particular characteristic, the resonator is remarkable in that the isotropic material is of the Ho, Tm:YAG type.

Thus, the resonator coupled to such an amplifying medium may in particular emit in the infrared and it may advantageously be applied to laser anemometry, vibrometry and telemetry, and more generally to distance measurements based on coherent detection. Moreover, a good amplifying medium (particularly of the Ho.Tm:YAG type) advantageously coupled with resonator qualities, in particular enables good stability and is adapted to providing high power particularly in continuous or quasi-continuous emission.

According to one particular characteristic, the resonator is remarkable in that the amplification means comprise an isotropic material.

According to one particular characteristic, the resonator is remarkable in that the isotropic material belongs to the group comprising:
isotropic crystals; and
Er:Yb codoped phosphate glass.

According to one particular characteristic, the resonator is remarkable in that the isotropic material is of the Nd:YAG type.

Thus, the invention enabling a wide choice of amplifier materials compatible with longitudinal and/or transverse pumping enables optimisation of the resonator as a function of the required application and particularly enables choosing one or several emission wavelengths.

For example, in the particular case of use of an Nd-YAP crystal (with a potential application for Raman laser pumping), two wave lengths 1064 and 1079 nm can be emitted depending on the size of the crystals. A laser with two wavelengths can be created by arranging and orienting the amplifying media and using Fresnel rhombohedrons (equivalent to a wide band quarter wave plate).

In general, the material used in isotropic or anisotropic amplification means is doped (particularly by rare earth ions) to enable amplification of the medium. Furthermore, the resonator used as a source may be configured so as to satisfy user eye safety criteria. Thus, for example, it may be doped with Ho³⁺ type rare earth ions.

According to one particular characteristic, the resonator is remarkable in that the resonator also comprises means in at least one of the modules of giving priority to one propagation direction of the first and second output beams in the arm concerned.

Thus, for example, one propagation direction can be given priority by using an optical diode that assures high stability of a resonator according to the invention.

According to one particular characteristic, the resonator is remarkable in that the resonator also comprises non-linear crystals in at least one of the modules, that generate a beam with harmonics, from one of the at least one optical beams passing through the non-linear crystals.

Thus, since the non-linear crystals are sensitive to polarisation, the invention enables the generation of harmonics (for example for a frequency doubler or tripler resonator) that is simple and efficient to implement, the emitted beam being unidirectional. Obviously, in this case, the output mirror(s) is (are) transparent to the harmonic(s) generated.

According to one particular characteristic, the resonator is remarkable in that the resonator also comprises an element in at least one of the modules belonging to the group comprising:
Fabry-Perot interferometers;
Fabry-Perot standards;
modulators; and
saturable absorbents.

Thus, different elements adapted to specific applications can be inserted in the cavity of a resonator according to the invention (particularly in an arm that does not contain an amplifying medium), and particularly:
a Fabry-Perot interferometer, for example if it is proven necessary to make the laser single mode longitudinal;
non-linear crystals for different applications, for example, for the generation of intra-cavity harmonics;
electro-optical or acoustic-optical modulators enabling many applications particularly in the telecommunications field, or for manufacturing pulse lasers in triggered mode or in blocked mode;
a saturable absorbent, particularly for a passive “Qswitch” type switch.

According to one particular characteristic, the resonator is remarkable in that it comprises means of separating the polarization of an incident beam, along a polarisation base, and four arms, the separation means being capable of separating the components of an incident beam from one of the arms such that:
the incident beam is reflected by the separation means, to be emitted to a first of the arms when the polarisation of the incident beam is oriented along a particular direction of the polarisation base; and
the incident beam is transmitted without being reflected through the separation means to be emitted to a second of the arms, the second arm being different from the first arm, when the polarisation of the incident beam is oriented along a second direction of the polarisation base;
each of the arms comprising means of redirecting the incident beam from the separation beams, means of redirecting and changing the polarisation being capable of redirecting the incident beam to the separation means and changing the direction of polarisation of the incident beam,
the resonator also comprising means of amplification of the incident beam called the beam to be amplified in at least three of the arms, the amplification means being adapted to be associated with longitudinal or transverse pumping means and being located on the path of the beam to be amplified, between the polarisation separation means and the redirection and polarisation changing means belonging to the arm concerned.

The invention also relates to a telecommunication device, remarkable in that it comprises a resonator like that described above.

In particular, this type of resonator (particularly if it is powerful) may be used to pump optical fibre amplifiers, for example of the Raman amplifier or Raman laser type amplifier and for amplifiers with Erbium doped fibres. The choice of the amplifier depends on the wavelength output by the resonator.

The invention also relates to a video projection device, remarkable in that it comprises a resonator like that described above.

Thus, a video projection device may be equipped with compact laser resonators according to the invention, with red, blue and green colours respectively (corresponding to the primary video colours). In order to obtain good chromaticity, each fundamental colour component defined by the red (610 to 630 nm), green (520 to 540 nm) and blue (450 to 460 nm) is covered. These colours can be obtained by a resonator comprising amplifying materials and ad-hoc doublers corresponding to the required colours. Thus, anisotropic amplifying materials can be used (for example of the Nd:YVO4 type to obtain a blue line at 456 nm by doubling the line at 912 nm) or isotropic (for example of the Nd:YAG type that can give a green line at 532 nm by doubling the line at 1064 nm).

This type of device equipped with resonators outputting approximately 1.5 Watt per colour can thus give a high quality projection on a cinema type screen.

The power of the video projection device according to the invention may also be very much less than 1.5 Watts or, on the contrary, it can be as high as several watts.

The advantages of telecommunication and video laser devices are the same as the advantages of the optical resonator, and are not described in more detail.

Other characteristics and advantages of the invention will become clearer after reading the following description of a preferred embodiment, given as a simple illustrative and non-limitative example, and the attached drawings among which:

FIGS. 1a to 1c show optical resonators, known in themselves;

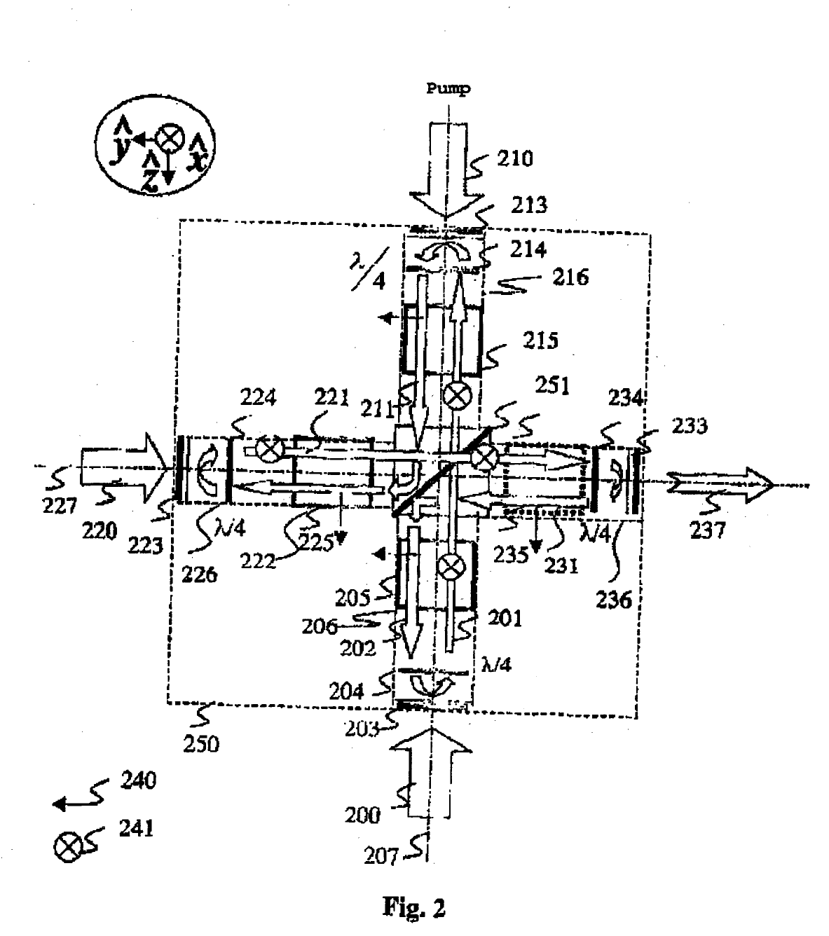

FIG. 2 shows a block diagram for an optical resonator with four arms according to a particular embodiment of the invention;

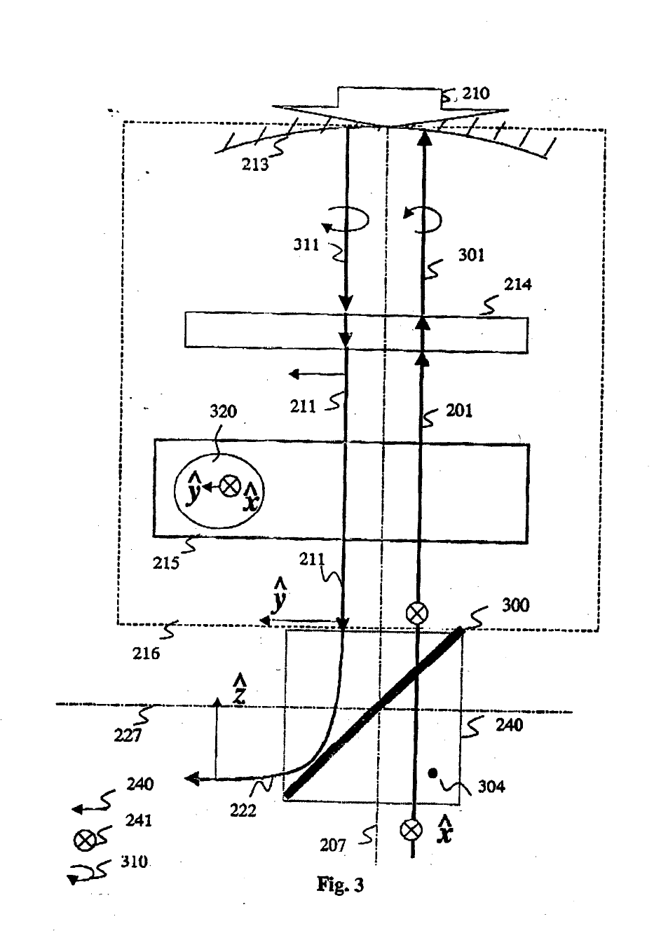

FIG. 3 shows a principle diagram of a polarisation separator cube and an arm used in the resonator in FIG. 2; and

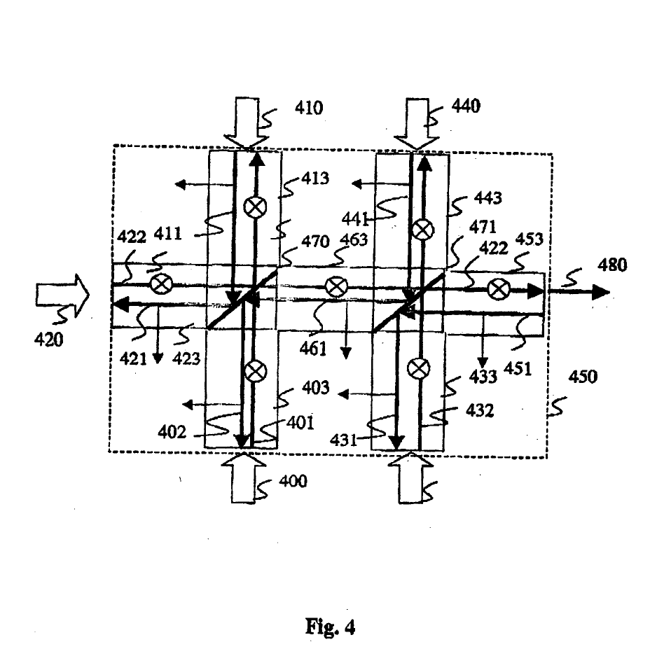

FIG. 4 describes a variant of a resonator comprising several polarisation separator cubes and six arms according to a particular embodiment of the invention.

The general principle of the invention is based on the use of a resonator in which there are one or two cross-propagative waves with rectilinear polarisations perpendicular to each other, the optical beam being divided into two fictitious optical paths forming a zero surface ring.

The resonator comprises one or several polarisation separation means, for example of the cube or semi-transparent polarisation separation plate type and arms, some of which themselves contain redirection and polarisation changing means, amplification means being inserted between the polarisation separation means and the redirection and polarisation changing means.

Thus for example, an incident beam enters into a separator cube, in particular its polarisation being such that it passes through the cube. At the output from the separator cube, the polarised optical beam is amplified by the amplification means (anisotropic crystal materials comprising the specific polarisation axes oriented according to the polarisation base of the cube for maximum efficiency, or other isotropic materials) before being reflected and having its polarisation changed perpendicularly on the redirection and polarisation changing means. The reflected beam is then amplified again in the amplifying means before penetrating the separator cube. Since its polarisation has been changed perpendicularly to the incident beam, it will be reflected in a direction imposed by the cube which, for example, forms an angle of 90° from the incident direction.

The mechanism for passing through the cube or reflecting on the cube, amplification and redirection/polarisation changing is reiterated inside the structure. Therefore the beam is amplified.

The method of making the amplifier enables a wide choice of amplification materials that may be isotropic or anisotropic with polarisation axes that depend on the polarisation base of the polarisation separation means, for example the materials being chosen as a function of the required gain.

FIG. 2 shows a block diagram of an optical resonator 250 according to the invention.

The resonator 250 is in the shape of a cross and comprises:
a polarisation separator cube 251 placed at the centre of the cross; and
four arms 206, 216, 226 and 236 forming the branches of a cross.

The cube 251 defining a polarisation base (x, y) or (x, z) (in this case the vectors are represented in bold and in italic) is oriented such that an incident beam entering into the cube with a polarisation:
in the plane (defined by the y, z axes according to the polarisation base) according to the diagram is reflected in a direction forming an angle of 90° with the incident beam; and
in a direction perpendicular to the plane according to the diagram (defined by an x axis according to the polarisation base) passes through the cube 251.

The vector space of polarization states is two-dimensional. It is always in the plane orthogonal to the propagation direction. Thus, two propagation directions are represented with reference to FIG. 2:
one is “vertical” and corresponds to propagation along the z axis in a positive or negative direction (forward and return), the associated polarisation base being (x, y) with a beam polarised along the x direction passing through the cube and the beam polarised along the reflected y direction; and
the other is “horizontal” and corresponds to propagation along the y axis, the associated polarisation base being (x, z) with a beam polarised along the x direction passing through the cube and a beam polarised along the z direction being reflected.

Each of the first three arms 206, 216 and 226 comprises the following, located in sequence along one of the corresponding y or z axes starting from the nearest point from the cube 251:
an amplification area or bar with an amplifying active medium 205, 215 and 225 respectively;
a quarter wave plate 204, 214 and 224 respectively; and
a mirror 203, 213 and 223 respectively.

Each of the amplification zones 205, 215 and 225 comprises an isotropic material (for example glass (particularly of the Er:Yb codoped phosphate type), polymer or isotropic crystal (particularly Nd:YAG or Ho,Tm:YAG) or an anisotropic material (particularly an anisotropic crystal (for example of the Nd:YAP, ND:YVO4 or Er:YAP type) or glass with dichroism), with its specific polarisation axes or preferred axes with respect to the direction of propagation of the light coincident with:
the x and y axes if propagation is along the z axis; and
the x and z axes if propagation is along the y axis.

Each of the amplification zones 205, 215 and 225 may be pumped transversely or longitudinally (in this case, as shown in FIG. 2, the pumps 200, 210 and 220 (for example of the laser diode type) associated with the amplification zones 205, 215 and 225 respectively and for which the wavelengths are adapted to the amplifying media are external to the resonator 250, the pump signal passing through the mirrors 203, 213 and 223 respectively according to techniques well known to an expert in the subject).

Note that mirrors 203, 213 and 223 have reflection coefficients equal to 100% for the intracavity signal and transmission coefficients of 100% for the pump signal.

The fourth arm 236 includes the following in sequence along the z axis:
a free area 235; and
a quarter wave plate 234; and
a partially transparent output mirror 233 enabling emission of an emitted beam 237.

According to a first variant not shown, the quarter wave plates 204, 214, 224 and 234 may be replaced by Fresnel rhombohedrons.

According to a second variant not shown, the cube may be replaced by a semi-reflecting plate placed diagonally along the y and z axes and parallel to the x axis, such that it allows a beam polarised along the x axis to pass through, and reflects a beam polarised along the y or z axis at an angle of 90°.

According to a third variant not shown, the free area 235 comprises:
a transversely pumped amplifying medium, enabling a larger gain of the resonator;
a Fabry-Perot interferometer, for example to make the laser monomode longitudinal;
non-linear crystals enabling the generation of harmonics;
electro-optical or acoustic-optical modulators: and/or
a saturable absorbent, particularly for a passive “Qswitch” type switch.

For the generation of intra-cavity harmonics, it would for example be possible to use an Nd:YAG amplifying media pair associated with potassium niobate (KNb03). When thermostat controlled, this crystal is very suitable because it has high damage threshold and is very efficient.

In the case of doubling of the I type in which the double frequency emerges polarised perpendicular to the polarisation of the signal at the fundamental frequency from which it originated, KNb03 has the advantage of having an index along the fundamental polarisation direction that is almost equal to the index of Nd:YAG, and which has the effect of reducing losses.

Note that in this type of doubling, there is necessarily a rectilinearly polarised fundamental wave, which is why it is advantageous to introduce such a doubling device in a portion of cavity in which polarisations are rectilinear, which is the case in the resonator 250.

FIG. 2 also shows an optical beam along one direction of the path. In order to facilitate understanding of the assembly as shown with reference to FIG. 2 and subsequent figures, the path of the signal composed of two cross-propagative waves with rectilinear polarisations perpendicular to each other, is divided into two fictitious optical paths arbitrarily shown on each side of the real optical axes 207 and 227 of the cavity. In reality, these fictitious optical paths are coincident with the real axes.

A rectilinear polarisation perpendicular to the plane of the figure, in other words along the x axis, was denoted using a cross 241 in a circle while an arrow 240 corresponds to a rectilinear polarisation parallel to the plane of the figure.

The direction of propagation of rectilinear polarised electromagnetic waves noted and represented in FIG. 2 has been chosen arbitrarily. This is not important since no “optical diode” device (possible insertion in arm 236) is present. Consequently, two cross-propagative waves are present. Only the polarizations need to be taken into account (although they are completely coherent with the chosen direction).

The closed space (optical plane) materialized by the end mirrors 203, 213, 223 and 233 marked on these real optical axes 207 and 227 defines the global path (crosswise) of two progressive waves maintained in the resonator.

Considering the above, this particular configuration demonstrates the concept of a configuration called “zero surface ring”.

Considering polarisation properties of the different elements of the resonator 250, an optical beam goes along a particular direction of the following path:
starting for example from the plate 204, a first beam 201 oriented along the z axis and polarised along the x axis is amplified by the medium 205 pumped by the pump 200;
it then passes through the cube 251 to be amplified by the medium 215 pumped by the pump 210;
it then passes through the plate 214, acquires a circular polarisation and is reflected by the mirror 213, and passes through the plate 214 again, its polarisation then being rectilinear along the y axis and the beam being marked as reference 211;
the beam 211, once again amplified by the medium 215 entering into the cube 251 is reflected along the y axis and acquires a rectilinear polarisation along the z axis (beam 225);
the beam 225 is then amplified by the medium 225 pumped by the pump 220, passes through the plate 224, acquires a circular polarization and is reflected by the mirror 223, passes once again through the plate 224, its polarisation then being rectilinear along the z axis and the beam being referenced 221;
the beam 221 once again amplified by the medium 225 passes through the cube 251 and the free zone 235;
as it passes through the plate 234, it then acquires a circular polarisation, part of the beam then being emitted outside the resonator 250 and another part of the beam being reflected by the mirror 233;
the reflected beam then acquires a rectilinear polarisation along the z axis as it passes through the plate 234 (beam 231);
the beam 231 then passes through the free zone 235, is reflected by the cube 251 along the z axis and with a polarisation along the y axis (beam 202);
the beam 202 is then amplified by the medium 205, passes through the plate 204, acquires a circular polarisation, is reflected by the mirror 203 and passes once again through the plate 204 to acquire a rectilinear polarisation along the x axis: it is then at the starting point of the path (beam 201).

FIG. 3 shows the cube 251 and the arm 216 of the resonator 250 that in particular includes the amplifying medium 215, the plate 214 and the mirror 213.

The polarisation separator cube 251 also called Polarising Beam Splitter (PBS) performs a two-fold function, namely:
it imposes a preferred base for orthogonal rectilinear polarisations, one corresponding to the x direction symbolized by a point or a cross in FIG. 2 and subsequent figures, and the other along the perpendicular y direction (in the plane of the figure for FIG. 2 and subsequent figures); and
the cube 251 acts as a switch for these two polarisations.

For the incident beam, we will consider a wave propagating along the direction of increasing z and with an arbitrary polarisation P. The polarisation of this wave is decomposed as a linear combination of two preferred polarisations, in other words P is equal to αx+βy. The α component along x will pass through the cube 251 while the β component along y will be reflected and will therefore be directed along another direction along z (90° reflection in FIGS. 2 and 3). The behaviour will be the same regardless of the input face of the device, the polarisation along x passes through the device and the polarisation along y is reflected on the surface equivalent to a mirror denoted 300. Point 304 on the CSP 251 symbolises the “passing” axis of this device (rectilinear polarisation perpendicular to the plane of the figure).

In the remainder of this description, we will use the term “π/2 phase shifters” for the quarter wave plates or Fresnel rhombohedrons inserted in the setup. The group composed of a π/2 phase shifter and associated mirror also performs a two-fold function:
it makes a direction change on the input beam; and
it changes the polarisation of the beam by an angle equal to 90°.

Thus, after correct orientation with respect to the polarisation phase imposed by the CSP 251 (specific axes at 45° or 135° from the CSP axes), the π/2 phase shifter, for example 214, enables transformation of a rectilinear polarisation along the x direction of the forward path 201 into a right circular polarisation (forward 301). Reflection of circularly polarised waves on the mirror 210 is a determining element. Thus, a right circular polarised wave corresponding to the forward path 301 is transformed into a left circular wave by reflection (to form the return 311) (conversely, a left circular polarisation is transformed into a right circular polarisation). The phase shifter 214 then enables transformation of a left circular polarisation (return 311) into a rectilinear polarisation (return 211) along the y axis perpendicular to the x axis. In other words, the forward path 201 and the return path 211 of a rectilinear polarised wave through the assembly composed of the π/2 phase shifter 214 and the mirror 210 will return a rectilinear polarised wave perpendicular to the incident polarisation. This role is exactly the same as for a so-called λ/2 phase plate that is oriented at 45° from the preferred axes of the CSP, except that the polarisation change action is accompanied by a change in the propagation direction.

According to the embodiment described, the mirrors 203, 213, 223 are curved to improve the stability of the resonator 250. The radius of curvature of each of these mirrors is optimised as a function of the size of the cavity according to methods known to those skilled in the art, who can also refer to the book “Physics of processes in coherent optical radiation generators” written by L. Tarassov and published by MIR Moscow publishers in 1985 and more particularly in chapter 2 and paragraphs 2.4 and subsequent paragraphs.

According to one variant particularly well adapted to small cavities, the resonator mirrors are plane.

The proposed configuration is such that the amplifier medium (active medium for the laser) 205, 215 and 225 respectively, is located between the CSP 551 and the group composed of the phase plate 204, 214 and 224 respectively, and the mirror 203, 213 and 223. This arrangement is the only arrangement that can perform the ring path function of the cavity if an anisotropic crystal is used as the amplifier.

An anisotropic medium has the particular property that it has a unique base 320 of orthogonal rectilinear polarisations for each propagation direction of light passing through it (for example along the x and y directions for the arm shown with reference to FIG. 2). These polarisation directions are called “specific polarisations” and they are associated with different propagation velocities (related to the “specific” indexes n₁ and n₂ associated with these two “specific” directions), we will denote them as u₁ and u₂ in the remainder and they are associated with phase velocities c/n₁ and C/n₂ respectively. Thus, the only polarisation that will not have its polarisation state transformed at the output from the crystal is a rectilinear polarisation parallel to u₁ and u₂. Any other polarisation will be transformed into a new elliptical polarisation (a linear combination of the α₁u₁+α₂e¹³u₂ type).

Due to this property of anisotropic media, we can see a fundamental difference in design with the resonator cavity described in the documents by Pr. Weber described above, and illustrated with reference to FIG. 1c. in the principle diagram for Pr. Weber's cavity, the active media 153, 163 and 173 respectively are inserted between the λ/4 plates 154, 164, 174 respectively and the mirrors 152, 162 and 172 respectively. In other words, in Pr. Weber's cavity, there are two cross-propagative fields passing through the active media, one with right circular polarisation, and the other with left circular polarisation. These polarisations must be maintained for the λ/4 plate to be able to make the transformation into waves with rectilinear polarisations and for the CSP to perform its switching role as a function of the polarisation. The only way that this can be achieved in this configuration is to use an isotropic active medium. In the case of an anisotropic active medium, this configuration would result in a medium through which two cross-propagative waves with different elliptical polarisations pass, and the λ/4 plate would not enable the transformation into rectilinear polarisations such that the CSP can perform its role. And at the output from the λ/4 plate (oriented as shown on the diagram), the polarisation would be an elliptical polarisation different again from the polarisation of the wave passing through the active medium, with the result that the CSP would give rise to two beams with orthogonal rectilinear polarisations in different arms, which would not enable a path around the cavity ring and therefore this cavity would no longer be useful.

According to the invention, the configuration proposed with the anisotropic crystal present in the amplifying medium 205, 215 (with its specific axes coinciding with the x and y axes of the CSP 251) and 225 (with its specific axes coincident with the x and z axes of the CSP 251) respectively and inserted between the CSP 251 and the unit composed of the π/2 phase shifter 204, 214 and 224 respectively (axes at 45° from the axes of the CSP 251) and the mirror 203, 213 and 223 respectively, enables circulation of a rectilinear polarised wave in the ring.

This configuration is also excessively simple in terms of the orientations to be given to the different elements:
the axes of the CSP 251 are fixed by construction;
the axes of the phase shifters 204, 214 and 223 are also known by construction and are marked; and
the laser crystal is cut according to specifications (specific to obtaining the laser effect) along the particular orientations of the crystalline axes of the material, the specific axes u₁ and u₂ are also easily identified and marked on the crystal as soon as it is cut.

It is then easy to install these different components in terms of orientation.

Depending on the type of amplifying medium selected for the envisaged application, it will be noted that such a configuration leaves a free choice about the use of isotropic or anisotropic active media:
if the medium is isotropic, the orientation of the medium may be arbitrary,
if the medium is anisotropic, the orientation of the crystal may be taken into account so as to protect specific axes imposed by the CSP 251.

Furthermore, the resonator 250 obtained may be relatively small. For example, if standard components are used, it would be possible to implement a resonator 250 comprising:
a cube with a 10 mm side;
amplifying media (optimised for longitudinal pumping) with a diameter of 5 or 7 mm and with a length equal to or less than 10 mm;
λ/4 plates with a thickness equal to 2 mm; and
concave mirrors on a thick substrate with a total thickness of 5 mm.

The result is thus an overall vertical length (arms with media 215 and 205) equal to 44 mm.

Obviously, the different adjacent parts of the resonator 250 (particularly the cube, the amplifying media, the λ/4 plates, the mirrors) may or may not be adjacent.

According to one variant of the invention, the amplifying media and the λ/4 plates are adjacent and are made from the same anisotropic material, this material being doped for amplifying media in order to obtain a gain, and not doped for λ/4 plates. Thus, an optical beam passing between a plate and an amplifying medium adjacent to it is not subjected to any loss when the plate passes into the amplifying medium and vice versa.

FIG. 4 shows a resonator 450 comprising two polarisation separator cubes according to a variant of the invention. The resonator 450 is particularly well adapted to high power emission.

The resonator 450 comprises:
two separator cubes 470 and 471;
five amplifying arms 403, 413, 423, 433 and 443, each of these arms being supplied by a pump 400, 410, 420, 430 and 440 respectively, and comprising an amplifying medium placed between a cube associated with the arm and a λ/4 phase shifter plate itself associated with a mirror;
an arm 463 connecting the two cubes 470 and 471 comprising a free zone without any λ/4 plates; and
an output arm 453 associated with the cube 471 and comprising a free zone, a λ/4 plate and a semi-transparent mirror enabling the emission of part of the internal beam to the outside of the resonator 450 forming a beam 480.

The arms 403, 413, 423, 433 and 443 are very similar to the arms 216, 226 and 227 and will not be described in more detail.

Similarly, the output arm 453, similar to the arm 236 illustrated above, is not described in more detail.

Moreover, the cubes 470 and 471 are similar to the cube 251 illustrated with reference to FIGS. 2 and 3.

However, care should be taken to orient the different elements mentioned above appropriately so that the resonator 450 forms a zero surface ring resonator, a beam for example following the path described below, starting from the plate of the arm 103 following a wave polarised along an x axis perpendicular to the plane of the figure:
cube 470 (forward 401), arm 413;
cube 470 (return 411 polarised along a y axis in the plane of the figure), arm 423 (forward 421 polarised along a z axis in the plane of the figure, perpendicular to the y axis);
cube 470 (return 422 polarised along the x axis), arm 463, cube 471, arm 453 the beam being partly emitted towards the outside, the other part being reflected;
cube 471 (return 451 polarised along the z axis), arm 433 (forward 431 polarised along the y axis);
cube 471 (forward 432 polarised along the x axis), arm 443;
cube 471 (return 441 polarised along the y axis), arm 463 (forward 461 polarised along the z axis), cube 470; and
arm 403 (return 402 polarised along the y axis).

Thus, the cubes 470 and 471 are oriented such that they are passing when an incident wave penetrates into one of these cubes with a polarisation along the x axis, and they are reflecting at an angle of 45° when an incident wave penetrates into one of these cubes with a polarisation along the y or the z axis.

Furthermore, the λ/4 plates and the mirrors present in each of the arms 403, 413, 423, 433 and 453 cause a direction change of the incident beam and a change of polarisation (a polarisation along the x axis changing to a polarisation along the y or z axis, and polarisation along the y or the z axis changing to a polarisation along the x axis).

Obviously, the first, second and third variants illustrated with reference to the description in FIG. 2 may also be used in the context of the embodiment described with reference to FIG. 4.

Thus, for example, according to the third variant illustrated above, the free zone present in the arms 453 and 463 may comprise:
a transversely pumped amplifying medium;
a Fabry-Perot interferometer;
a Fabry-Perot standard;
non-linear crystals for the intra-cavity generation of harmonics;
electro-optical or acoustic-optical modulators and/or
a saturable absorbent.

According to one variant not shown, the resonator comprises several polarisation cubes similar to cubes 470 and 471, each of the sides of each cube being associated with:
a connection arm to another cube similar to arm 263;
one of the amplifier arms similar to arms 206, 216 and 226; or
an output arm similar to arm 453.

Thus, this type of resonator structure may include a large number of amplifier arms so that a high emission power and high usage flexibility are possible (the arms and the components of the elementary entities may be easily combined as a function of the needs of the envisaged application).

According to one variant not shown, two neighbouring cubes are placed adjacent to each other without being connected by an arm, since the arm containing a free area is optional. This embodiment in particular leads to a resonator structure with at least two relatively compact cubes.

Obviously, the resonator is not limited to the example embodiments mentioned above.

In particular, those skilled in the art could make any variant in the structure of the zero surface ring resonator, particularly in the types of component elements and particularly:
in the polarisation separation means (PBS cube, polarisation plate, etc.);
in beam redirection and polarisation changing means (λ/4 plate or Fresnel rhombohedron associated with a mirror); and/or
in the amplification means inserted between the polarisation separation means and the beam redirection and polarisation changing means.

According to the invention, the polarisation separation means may also separate a polarised beam along two non-orthogonal directions (for example at an angle of 30°), for example for use of the resonator requiring a particular form or structure.

According to yet another variant, the cube(s) are chosen such that the arms are not all in the same plane.

Note also that the invention is not limited to the case in which the resonator is pumped transversely, but includes any type of longitudinal pumping.

Note also that the amplification means according to the invention comprise various types of amplifying media (anisotropic crystals, isotropic crystals, polymers, glass, etc.) to obtain emission wavelengths within ranges that are themselves variable.

1. An optical ring resonator allowing at least one optical beam to circulate inside the said resonator forming a zero surface ring, said the resonator comprising a plurality of modules, each module itself comprising:
means of separating the polarization of an incident beam entering the said module, according to a polarization base ((x,y), (x,z));
a first arm; and
a second arm;
the separation means being capable of separating:
a first component of the said incident beam oriented along a first direction of the said polarisation base ((x,y)), forming a first output beam emitted to the said first arm ; and
a second component of the said incident beam oriented along a second direction ((x,z)) of the said polarisation base, forming a second output beam emitted to the said second arm;
at least one of the first and the second arm comprising means of redirection and changing the polarization of the said first and second output beams respectively, the said redirection and polarization changing means being adapted to redirecting the said first or second output beam to the said separation means and changing the polarisation direction of the said first or second output beam to form an incident beam input into another of the said modules;
wherein said resonator also comprises amplification means in at least one of the said modules, to amplify at least one of the said first and second output beams, referred to as at least one beam to be amplified, the said amplification means being adapted to being associated with longitudinal or transverse pumping means and being located on the path of the said at least one beam to be amplified, between the said polarization separation means and the said redirection and polarization changing means belonging to the arm concerned.

2. The resonator according to claim 1, wherein said separation means comprise a polarisation separator cube.

3. The resonator according to claim 1, wherein said separation means comprise a semi-transparent plate with polarisation separation.

4. The resonator as claimed in any of claim 1, wherein said separation means are common to all modules.

5. The resonator as claimed in any of claim 1, wherein all said modules comprise at least two sub-assemblies, all modules of the same subassembly of modules sharing common separation means.

6. The resonator as claimed in claim 1 , wherein said redirection and polarisation changing means comprise:
a mirror positioned so as to reflect the said first or second output beam; and
means of shifting the phase of the said first or second output beam;
such that the said first or second output beam is:
firstly subjected to a phase shift through an angle equal to π/2 radians by the said phase shifting means;
then reflected by the said mirror; and
finally, the phase is shifted again by an angle equal to π/2 radians by the said phase shifting means.

7. The resonator according to claim 6, wherein said phase shifting means and the said amplification means comprise the same undoped material in the said phase shifting means and doped material in the said amplification means and are adjacent such that the first or second output beam transits from the said amplification means to the said phase shifting means and vice versa without changing medium.

8. The resonator as claimed in claim 6, wherein said phase shift means comprise a quarter wave plate.

9. The resonator as claimed in claim 6, wherein said phase shift means comprise a Fresnel rhombohedron.

10. The resonator as claimed in claim 6, wherein said mirror is concave.

11. The resonator as claimed in claim 6, wherein said mirror is plane.

12. The resonator as claimed in claim 1, wherein said amplification means comprise an anisotropic material with its specific polarisation axes corresponding to the polarisation directions of said polarisation base.

13. The resonator according to claim 12, wherein said anisotropic material belongs to the group comprising:
anisotropic crystals; and
glass with dichroism.

14. The resonator as claimed in claim 12, wherein said anisotropic material belongs to the group comprising:
Nd:YAP type materials;
Nd:YVO4 type materials; and
Er:YAP type materials.

15. The resonator as claimed in claim 1, wherein said amplification means comprise an isotropic material.

16. The resonator according to claim 15, wherein said isotropic material belongs to the group comprising:
isotropic crystals; and
Er:Yb codoped phosphate glass.

17. The resonator as claimed in claim 15, wherein isotropic material is of the Nd:YAG type.

18. The resonator as claimed in claim 15, wherein isotropic material is of the Ho,Tm:YAG type.

19. The resonator as claimed in claim 1, wherein said resonator also comprises, in at least one of the said modules, means of giving priority to one propagation direction of the said first and second output beams in the said arm concerned.

20. The resonator as claimed in claim 1, wherein said resonator also comprises, in at least one of the said modules, non-linear crystals capable of generating a beam with harmonics, from one of the said at least one optical beams passing through the said non-linear crystals.

21. The resonator as claimed in claim 1, wherein said resonator comprises an element in at least one of the said modules belonging to the group comprising:
Fabry-Perot interferometers;
Fabry-Perot standards;
modulators; and
saturable absorbents.

22. The resonator resonator as claimed in claim 1, wherein it comprises means of separating the polarization of an incident beam, along a polarisation base, and four arms, the said separation means being capable of separating the components of an incident beam from one of the arms such that:
the said incident beam is reflected by the said separation means, to be emitted to a first of the said arms when the polarisation of the incident beam is oriented along a first direction of the polarisation base; and
the said incident beam is transmitted without being reflected through the said separation means to be emitted to a second of the said arms, the second arm being different from the said first arm, when the polarisation of the said incident beam is oriented along a second direction of the said polarisation base;
each of the arms comprising means of redirecting the said incident beam from the said separation beams, the said means of redirecting and changing the polarisation being capable of redirecting the said incident beam to the said separation means and changing the direction of polarisation of the said incident beam,
the said resonator also comprising means of amplification of the said incident beam called the beam to be amplified in at least three of the said arms, the amplification means being adapted to be associated with longitudinal or transverse pumping means and being located on the path of the said beam to be amplified, between the said polarisation separation means and the said redirection and polarisation changing means belonging to the arm concerned.

23. A telecommunication device comprising a resonator as claimed in claim 1.

24. A video projection device, comprising a resonator as claimed in claim 1.
